(19) United States
(12) Patent Application Publication
(10) Pub. No.: US 2023/0383376 A1
(43) Pub. Date: Nov. 30, 2023

(54) PROCESS FOR TREATING A MATERIAL

(71) Applicant: Zeotech Limited, Brisbane, Queensland (AU)

(72) Inventors: James VAUGHAN, St. Lucia (AU); Hong PENG, Middle Park (AU)

(21) Appl. No.: 18/248,646

(22) PCT Filed: Oct. 19, 2021
(86) PCT No.: PCT/AU2021/051214

§ 371 Date: Apr. 11, 2023

(30) Foreign Application Priority Data
Oct. 20, 2020 (AU) 2020903792

(51) Int. Cl. C22B 3/12; C01B 39/02; C22B 21/06

(52) U.S. Cl. CPC C22B 3/12; C01B 39/02; C22B 21/06

(57) ABSTRACT

A process for treating a material to remove sulphates or other impurities therefrom comprises a) subjecting the material to a leaching step to selectively dissolve sulphate-containing material or dissolve other impurities from the material and/or to passivate gypsum, b) separating a leach solution generated in step (a) from solids, and c) treating the solids from step (b). The solids from step (b) may be leached to dissolve Si and/or Al and the pregnant leach solution can be treated to precipitate zeolites. The process can be used to make zeolites from feed materials, including leached spodumene residue. Step (a) is a pre-wash/pre-leach step that removes impurities that could otherwise interfere with the zeolite precipitation step or require further processing of the pregnant leach liquor.

### TECHNICAL FIELD

The present invention relates to a process for treating a material. In one embodiment, the process removes sulphates or other impurities from the material. In another embodiment, the treated material may be further treated to form zeolites.

### BACKGROUND ART

Zeolites are microporous aluminosilicate materials. They have found widespread commercial use as adsorbents and catalysts. Zeolites that are used on a commercial scale are synthesised in industrial processes to ensure that the desired purity of the zeolite for use in the commercial process is achieved. In this regard, although zeolites do occur in nature, natural zeolites are usually found with impurity elements and minerals, thereby rendering them less useful for commercial use.

Industrial manufacture of zeolites at present involves forming solutions of aluminium and silicate and mixing those solutions together under conditions that result in precipitation of the zeolites. To give one example, a sodium aluminate solution is mixed with a sodium silicate solution at an alkaline pH (arising from the aluminate in the solution) under stirring and with the presence of seed particles and/or templating agents at a temperature of around 90° C. This results in precipitation of the zeolites.

Zeolites are crystalline microporous aluminosilicates that have three dimensional frameworks made of SiO₄ and AlO₄. The zeolites contain cages of molecular dimensions which can have large central pores formed by rings of different diameters. Due to the zeolites' microporous properties, they have many applications within various fields such as in laundry detergents, ion exchange and water treatment. There are also many different zeolites which can exist naturally or can be synthesised, synthetic zeolites are more expensive, but they have a much wider range of applications than natural zeolites. One of the main research topics is the zeolites' ability to adsorb metal cations to remove them from waste water streams due to their net negative charge, high porosity and potential low cost. Most reports relating to this issue focus on the zeolite LTA (also called Zeolite 4A due to pore size, 4 Å, the two terms will be used interchangeably in this specification). Zeolite 4A has been synthesised from coal fly ash (CFA), which showed very similar maximum adsorption capacities with a difference of 3 mg/g for Cu²⁺ (50.45 and 53.45 mg/g for CFA and commercial, respectively). Coal fly ash synthesised zeolite A (LTA), showed greater removal efficiency compared to zeolite X synthesised from coal fly ash which achieved 47 and 83 mg/g adsorption capacity for Cu²⁺ and Zn²⁺. The highest adsorption capacity achieved was using 0.5 g LTA which is extremely small when comparing to the capacities of other synthetic zeolites or even against some of the natural zeolite materials.

Spodumene is a mineral consisting of lithium aluminium silicate, LiAl(SiO₃)₂. It contains approximately 6%-9% lithium as lithium oxide. The lithium is used to produce lithium carbonate and other salts and, in turn, lithium cobalt oxide or other lithium compounds, which can be used in batteries.

Spodumene is a pyroxene mineral found in lithium-bearing pegmatites, along with other minerals such as quartz, feldspar and mica. Spodumene is separated from the ore by physical separation methods, typically flotation, to produce a spodumene concentrate. Australia is the largest exporter of spodumene concentrate in the world, with most originating from Western Australia.

Due to the high solubility of Li₂SO₄ in aqueous systems (34.8 g/100 g H₂O at 20° C.) and relatively low cost of sulfuric acid, the sulfation processing has become the most common techniques for processing spodumene to recover lithium. Spodumene occurs in nature as α-spodumene. However, the direct extraction of lithium from naturally occurring α-spodumene by acid leaching is not feasible due to the high stability of its crystalline structure, which makes the α-spodumene refractory to acid attack by sulphuric acid. To address this issue, the α-spodumene is converted to β-spodumene by heating at above 850° C. The β-spodumene can then be leached with sulphuric acid. After the heat treatment and sulfuric acid digestion, water leaching followed by carbonate precipitation is carried out to form lithium carbonate. This process generates large amounts of spodumene leaching residues. Due to the precipitation process requiring addition of calcium containing materials such as lime or calcium hydroxide, the leached spodumene residues normally contain gypsum that is also generated during the precipitation process. The leaching residue is often termed ‘lithium slag (LS)’. Typically, there will be about 9 tonnes of lithium slag produced per tonne of lithium salts obtained from the spodumene ore.

Lithium slag is generally thought of as a low value waste product. However, some authors have presented processes for producing zeolites from lithium slag. Lithium slag contains both silicon and aluminium, which are the main components of the zeolites. For example, Lin et al. Chinese Journal of Chemical Engineering, 23 (2015) pp 1768-1773, describe a process for synthesising zeolites from lithium slag. The lithium slag used in this paper had the following composition:

| Chemical component | Mass fraction % |
|---|---|
| SiO₂ | 70.67 |
| Al₂O₃ | 27.24 |
| Fe₂O₃ | 0.52 |
| SO₃ | 0.45 |
| CaO | 0.29 |
| K₂O | 0.22 |
| MgO | 0.16 |
| Na₂O | 0.13 |
| P₂O₅ | 0.12 |
| Others | <0.1 |

In this paper, zeolite FAU/LTA was synthesised from lithium slag by adding 200 ml of NaOH solution to 50 g of lithium slag, followed by gentle agitation for 10 minutes and moderate temperature for 2 hours. Then 250 ml of deionised water was added to the solution. After aging for two hours, the resulting mixture was kept heated at an appropriate temperature for 9 hours. The solid product was then filtered, washed with deionised water and dried in an oven. Zeolite FAU/LTA was obtained. In an alternative process, 200 ml of mother liquid recovered from zeolite synthesis and a certain amount of NaOH solution was added to 50 g of lithium slag to satisfy base concentration required by zeolite synthesis. Then a certain amount of NaAlO₂ was added to keep the molar ratio of Si to Al the same, followed by gentle agitation for 10 minutes and moderate temperature for 2 hours. Then 250 ml of deionised water was added to the solution. After aging for 2 hours, the resulting mixture was kept heated at an appropriate temperature for 9 hours. The solid product was filtered, washed and dried in an oven overnight.

Jadarite is another lithium-containing ore that can be processed to recover lithium therefrom. Jadarite is a sodium lithium boron silicate hydroxide having a nominal composition of (LiNaSiB₃O₇(OH) or Na₂OLi₂O(SiO₂)₂(B₂O₃)₃H₂O). Lithium and borates can be extracted from jadarite, leaving a leached jadarite residue that contains recoverable materials. The leached jadarite residue will also typically contain sulphates due to the leaching process used to recover lithium and borates therefrom.

A number of other ores are also treated and/or leached under conditions that result in appreciable quantities of sulphates in the treated ores (throughout this specification, the term “ore” is to be taken to refer to ores and concentrates). Subsequent processing of the treated ores can be made more difficult by the sulphates.

It will be clearly understood that, if a prior art publication is referred to herein, this reference does not constitute an admission that the publication forms part of the common general knowledge in the art in Australia or in any other country.

### SUMMARY OF INVENTION

The present invention is directed to a process for producing zeolites from leached spodumene residue, which may provide the consumer with a useful or commercial choice.

With the foregoing in view, the present invention in a first aspect, resides broadly in a process for treating a material to remove sulphates or other impurities therefrom, the process comprising:
a) subjecting the material to a leaching step to selectively dissolve sulphate-containing material or dissolve impurities from the material and/or to passivate gypsum,
b) separating a leach solution generated in step (a) from solids, and
c) treating the solids from step (b).

In one embodiment, the other impurities may comprise one or more of arsenic, boron, tungsten, phosphorus and vanadium.

In step (a), the material is subjected to a pre-wash or a pre-leaching step to selectively dissolve gypsum from the material and/or to passivate gypsum. In one embodiment, a neutral leach or a water wash at neutral pH is used in this step. In another embodiment, an alkaline leach is used in this step. In preferred embodiments, the pre-wash or pre-leach of step (a) is conducted to minimise or avoid dissolution of silicate/silicon components and aluminium components from the material. In some embodiments, step (a) is conducted at a temperature of less than 50° C., or less than 40° C., or at ambient temperature, or without any additional heating. In some embodiments, relatively mild alkaline conditions are used. In one embodiment, an alkaline solution corresponding to 0.5 to 2M NaOH, or 0.5 to 1.5M NaOH, or 0.5 to 1.25M NaOH, or 0.5 to 1M NaOH is used. Other alkaline solutions having a similar pH able to be used. In one embodiment, the leaching solution comprises an alkaline solution. The alkaline solution suitably comprises sodium hydroxide solution, although other hydroxide solutions such as KOH may also be used. Alkaline carbonate solutions, such as sodium carbonate (Na₂CO₃) solutions, may also be used in this step. In some embodiments, a mixture of a hydroxide and a carbonate may be used, for example, a mixture of sodium hydroxide and sodium carbonate. Sodium hydroxide is widely available and relatively inexpensive, and sodium carbonate can be less expensive than sodium hydroxide, so one or both are preferred for use in the leaching step. In some embodiments, step (a) is conducted with a solids loading of approximately 50 to 250 g, or from 50 to 200 g, or from 100 to 200 g of leached spodumene residue per litre of leachant solution. A residence time of from about 0.25 to about 4 hours, or from about 0.5 to about 2 hours, or from about 0.5 to about 1 hour, may be used in step (a).

In step (a), at least some of the sulphates, such as gypsum, present in the material is dissolved. Some of the dissolved gypsum may re-precipitate as calcium hydroxide, Ca(OH)₂, which may coat some of the remaining gypsum, which acts to passivate the remaining gypsum. The present inventors have found that a neutral leach/water wash in step (a) will reduce the gypsum content of the solids but greater removal or passivation of gypsum is achieved by using an alkaline leach in step (a).

In some embodiments, step (a) reduces the amount of soluble gypsum or soluble sulphate in the material by at least 50%, or by at least 60%, or by at least 70%, or by at least 80%, or by at least 90%, or around 90%. In other words, the solids removed from step (a) have a soluble gypsum or soluble sulphate content that has been reduced from the soluble gypsum or soluble sulphate content in the feed material by at least 50%, or by at least 60%, or by at least 70%, or by at least 80%, or by at least 90%, or around 90%.

The solids from step (a) have reduced levels of gypsum or sulphate and preferably have low levels of gypsum or sulphate, when compared to the starting material.

In other embodiments, step (a) reduces the levels of other impurities in the feed material by the amounts stated above for the reduction in sulphate.

In one embodiment, step (a) reduces the amount of sulphate and/or other impurities without removing significant silicate/silicon components and/or aluminium components from the material. In one embodiment, less than 20% of the silicate/silicon components and/or aluminium components, or less than 10% of the silicate/silicon components and/or aluminium components, in the feed material are dissolved in step (a).

In some embodiments, step (a) provides a step for removing sulphate and/or other impurities from the material without removing significant silicate/silicon components and/or aluminium components from the material. In this manner, the silicate/silicon components and/or aluminium components in the feed material largely report to the solids in step (b) and the silicate/silicon components and/or aluminium components and then be recovered and/or used to form other products.

The solids from step (a) are separated from the solution generated in step (a) using any solid/liquid separation technique known to the person skilled in the art. Examples include filtration, settling, decantation, sedimentation, use of hydrocyclones, centrifugation, thickening, or the like. The particular solid/liquid separation technique is not especially critical to the present invention.

In some embodiments, particularly in embodiments that are treating a material having high total sulphate content, it may be necessary to subject the material to two or more pre-wash or pre-leach stages. Accordingly, in one embodiment, the process of the present invention comprises repeating steps (a) and (b) one or more times.

The solids from step (b) may be washed prior to step (c). The solids may be washed with wash water.

In one embodiment, the material comprises leached spodumene residue. In another embodiment, the material comprises leached jadarite residue. In another embodiment, the material comprises a mining tailings containing silicate/silicon components and/or aluminium components. In another embodiment, the material comprises a kaolin-containing material or a kaolinite-containing material, or a clay-containing material. In other embodiments, the material may comprise aluminium hydroxy-sulfates, fly ash, or colloidal silica. A mixture of two or more materials may be treated.

Step (c) may comprise any further treatment of the solids from step (b) to recover valuable material therefrom or to form other materials. In one embodiment, step (c) comprises a leaching step to leach Si and/or Al into solution.

In one embodiment, the process of the first aspect of the present invention further comprises:
c) leaching the solids from step (b) to dissolve aluminium and silicate into solution and form a pregnant leach solution containing dissolved aluminium and silicon/silicate,
d) separating the pregnant leach solution from solids, and
e) treating the pregnant leach solution to form zeolites.

In the leaching step, the solid material from step (b) is leached in a leaching solution. This dissolves the aluminium components and the silicate components from the solid material. However, impurity components that were present in the solid material do not dissolve or dissolve to only a small extent and remain as a solid residue. It will be appreciated that the undissolved solid residue in the leaching step is in the form of particulate material. The leaching step is generally conducted with agitation in order to ensure adequate mixing between the solid material and the leach solution, which improves leaching kinetics. The impurity components or other components of the solids may include quartz, calcite and calcium hydroxide.

In one embodiment, the leaching solution comprises an alkaline solution. The alkaline solution suitably comprises sodium hydroxide solution, although other hydroxide solutions such as KOH may also be used. Sodium hydroxide is widely available and relatively inexpensive, so it is preferred for use in the leaching step. Alkaline carbonate solutions, such as sodium carbonate solutions, may also be used in this step.

In step (c), the solids generated in step (a) are leached to dissolve silicate/silicon and aluminium therefrom to generate a pregnant leach solution containing dissolved silicate/silicon and dissolved aluminium/aluminates. The leaching step of step (c) will typically utilise higher temperatures and higher caustic concentrations than the pre-leaching or pre-washing step of step (a). In one embodiment, step (c) comprises leaching the solids with an alkaline leach solution corresponding to a 2M to 6M NaOH solution, or a leach solution corresponding to a 3M to 5M NaOH solution, or a leach solution corresponding to a 4M to 4.5M NaOH solution, or a leach solution corresponding to about 4M NaOH. The temperature of the leaching step in step (c) may range from 50° C. up to the boiling point of the mixture at atmospheric pressure, or from 60° C. to 90° C., or from 60° C. to 80° C., or from 70° C. to 80° C., or about 70° C. The solids may be present in an amount of from 30 to 95 g/L, or from 40 to 75 g/L, or from 50 to 75 g/L, in step (c). A leaching time of up to 6 hours, or from about 0.5 to about 6 hours, or from about 2 to about 4 hours, may be suitable in step (c).

In some embodiments, the leach solution used in step (c) may have dissolved Al and/or dissolved Si therein. In one embodiment, the leach solution may have a concentration of up to 100 mM Al and a concentration of up to 100 mM Si dissolved therein.

In the leaching step, the solid material from step (b) is leached in a leaching solution. This dissolves the aluminium components and the silicate components from the solid material. However, impurity components that were present in the solid material or other components of the solids do not dissolve or dissolve to only a small extent and remain as a solid residue, quartz, calcite and calcium hydroxide. It will be appreciated that the undissolved solid residue in the leaching step is in the form of particulate material. The leaching step is generally conducted with agitation in order to ensure adequate mixing between the solid material and the leach solution, which improves leaching kinetics.

In one embodiment, the leaching solution comprises an alkaline solution. The alkaline solution suitably comprises sodium hydroxide solution, although other hydroxide solutions such as KOH may also be used. Sodium hydroxide is widely available and relatively inexpensive, so it is preferred for use in the leaching step. Alkaline carbonate solutions, such as sodium carbonate solutions, may also be used in this step.

The pregnant leach solution containing dissolved aluminium and dissolved silicate that is generated in step (c) is separated from the solids using any solid/liquid separation technique known to be suitable to the person skilled in the art. The separated solids residue, which contain quartz, calcite and calcium hydroxide, may be disposed of, for example in a tailings dam, in a landfill, or sent for any other use.

The pregnant leach solution obtained from step (c) is then treated to precipitate or crystallise zeolites therefrom. In one embodiment, zeolite LTA is formed from the pregnant leach solution. An additional source of aluminium is likely to be needed to be added to the pregnant leach solution in order to ensure that there is sufficient aluminium present in the solution to obtain the correct ratio of silicon to aluminium in the solution to obtain the desired zeolite. In one embodiment, step (e) comprises adding aluminate to the pregnant leach solution. Sodium aluminate they be used as the source of aluminate.

In step (e), the solution may be aged at a temperature of from about 60 to 95° C. with slow agitation for a period of from about 1 to about 4 hours.

In embodiments where aluminate is added to the solution, the aluminate may be added at room temperature and the solution may then be aged for about 15 to 30 minutes, followed by heating up to 80 to 95° C. with slow agitation for 1 to 4 hours. Zeolite LTA can be formed under these conditions. Other conditions may be used if other zeolites are designed to be formed. Seed particles may be added in step (e), if desired or required. The skilled person will readily understand how to generate zeolites, such as zeolite LTA, in step (e).

In other embodiments, step (e) may be conducted at a temperatures of from 60 to 95° C., or from 60 to 80° C., or from 60 to 70° C., with stirring that may be gentle agitation or vigorous agitation, for a period of from 30 minutes to 4 hours, or from 1 hour to 4 hours. Zeolite seed crystals may be added in step (e) to control the size of the zeolites being formed. The seed crystals may be added in an amount of from 10-20 g/L. The skilled person will understand that the addition of seed crystals may be varied in order to control formation of the zeolites. If required, a source of additional Al, such as an aluminate solution, may also be added to ensure the desired ratio of Al to Si is obtained in the precipitation step.

After zeolites have been formed in step (e), the solid zeolites may be separated from the solution. The solution will contain dissolved silicate/silicon and dissolved aluminium. This solution may be recycled to step (c) to minimise loss or wastage of the dissolved silicate/silicon and dissolved aluminium.

In a second aspect, the present invention provides a process for producing zeolites from leached spodumene residue, the leached spodumene residue including gypsum, the process comprising
a) subjecting the leached spodumene residue to a leaching step to selectively dissolve gypsum from the leached spodumene residue and/or to passivate gypsum,
b) separating a leach solution generated in step (a) from solids,
c) leaching the solids from step (b) to dissolve aluminium and silicate into solution and form a pregnant leach solution containing dissolved aluminium and silicon/silicate,
d) separating the pregnant leach solution from solids, and
e) treating the pregnant leach solution to form zeolites.

In one embodiment, a solution recovered from step (e) is at least partly recycled to step (c).

In step (a), the leached spodumene residue is subjected to a pre-wash or a pre-leaching step to selectively dissolve gypsum from the leached spodumene residue and/or to passivate gypsum. In one embodiment, a neutral leach or a water wash at neutral pH is used in this step. In another embodiment, an alkaline leach is used in this step. In preferred embodiments, the pre-wash or pre-leach of step (a) is conducted to minimise or avoid dissolution of silicate/silicon components and aluminium components from the leached spodumene residue. In some embodiments, step (a) is conducted at a temperature of less than 50° C., or less than 40° C., or at ambient temperature, or without any additional heating. In some embodiments, relatively mild alkaline conditions are used. In one embodiment, an alkaline solution corresponding to 0.5 to 2M NaOH, or 0.5 to 1.5M NaOH, or 0.5 to 1.25M NaOH, or 0.5 to 1M NaOH is used. Other alkaline solutions having a similar pH able to be used. In one embodiment, the leaching solution comprises an alkaline solution. The alkaline solution suitably comprises sodium hydroxide solution, although other hydroxide solutions such as KOH may also be used. Alkaline carbonate solutions, such as sodium carbonate (Na₂CO₃) solutions, may also be used in this step. Sodium hydroxide is widely available and relatively inexpensive, so it is preferred for use in the leaching step. In some embodiments, step (a) is conducted with a solids loading of approximately 50 to 250 g, or from 50 to 200 g, or from 100 to 200 g of leached spodumene residue per litre of leachant solution. A residence time of from about 0.25 to about 4 hours, or from about 0.5 to about 2 hours, or from about 0.5 to about 1 hour, may be used in step (a).

In step (a), at least some of the gypsum present in the leached spodumene residue is dissolved. Some of the dissolved gypsum may re-precipitate as calcium hydroxide, Ca(OH)₂, which may coat some of the remaining gypsum, which acts to passivate the remaining gypsum. The present inventors have found that a neutral leach/water wash in step (a) will reduce the gypsum content of the solids but greater removal or passivation of gypsum is achieved by using an alkaline leach in step (a).

In some embodiments, step (a) reduces the amount of soluble gypsum or soluble sulphate in the leached spodumene residue by at least 50%, or by at least 60%, or by at least 70%, or by at least 80%, or by at least 90%, or around 90%. In other words, the solids removed from step (a) have a soluble gypsum or soluble sulphate content that has been reduced from the soluble gypsum or soluble sulphate content in the feed leached spodumene residue by at least 50%, or by at least 60%, or by at least 70%, or by at least 80%, or by at least 90%, or around 90%.

The solids from step (a) have reduced levels of gypsum or sulphate and preferably have low levels of gypsum or sulphate, when compared to the starting leached spodumene residue.

The solids from step (a) are separated from the solution generated in step (a) using any solid/liquid separation technique known to the person skilled in the art. Examples include filtration, settling, decantation, sedimentation, use of hydrocyclones, centrifugation, thickening, or the like. The particular solid/liquid separation technique is not especially critical to the present invention.

In some embodiments, particularly in embodiments that are treating a leached spodumene residue having high total sulphate content, it may be necessary to subject the leached spodumene residue to two or more pre-wash or pre-leach stages. Accordingly, in one embodiment, the process of the present invention comprises repeating steps (a) and (b) one or more times.

The solids from step (b) may be washed prior to step (c). The solids may be washed with wash water.

In step (c), the solids generated in step (a) are leached to dissolve silicate/silicon and aluminium therefrom to generate a pregnant leach solution containing dissolved silicate/silicon and dissolved aluminium/aluminates. The leaching step of step (c) will typically utilise higher temperatures and higher caustic concentrations than the pre-leaching or pre-washing step of step (a). In one embodiment, step (c) comprises leaching the solids with an alkaline leach solution corresponding to a 2M to 6M NaOH solution, or a leach solution corresponding to a 3M to 5M NaOH solution, or a leach solution corresponding to a 4M to 4.5M NaOH solution, or a leach solution corresponding to about 4M NaOH. The temperature of the leaching step in step (c) may range from 50° C. up to the boiling point of the mixture at atmospheric pressure, or from 60° C. to 90° C., or from 60° C. to 80° C., or from 70° C. to 80° C., or about 70° C. The solids may be present in an amount of from 30 to 95 g/L, or from 40 to 75 g/L, or from 50 to 75 g/L, in step (c). A leaching time of up to 6 hours, or from about 0.5 to about 6 hours, or from about 2 to about 4 hours, may be suitable in step (c).

In some embodiments, the leach solution used in step (c) may have dissolved Al and/or dissolved Si therein. In one embodiment, the leach solution may have a concentration of up to 100 mM Al and a concentration of up to 100 mM Si dissolved therein.

In the leaching step, the solid material from step (b) is leached in a leaching solution. This dissolves the aluminium components and the silicate components from the solid material. However, impurity components that were present in the solid material or other components of the solids do not dissolve or dissolve to only a small extent and remain as a solid residue. It will be appreciated that the undissolved solid residue in the leaching step is in the form of particulate material. The impurity components or other components of the solids may include quartz, calcite and calcium hydroxide. The leaching step is generally conducted with agitation in order to ensure adequate mixing between the solid material and the leach solution, which improves leaching kinetics.

In one embodiment, the leaching solution comprises an alkaline solution. The alkaline solution suitably comprises sodium hydroxide solution, although other hydroxide solutions such as KOH may also be used. Sodium hydroxide is widely available and relatively inexpensive, so it is preferred for use in the leaching step. Alkaline carbonate solutions, such as sodium carbonate solutions, may also be used in this step.

The pregnant leach solution containing dissolved aluminium and dissolved silicate that is generated in step (c) is separated from the solids using any solid/liquid separation technique known to be suitable to the person skilled in the art. The separated solids residue, which contain quartz, calcite and calcium hydroxide, may be disposed of, for example in a tailings dam, in a landfill, or sent for any other use.

The pregnant leach solution obtained from step (c) is then treated to precipitate or crystallise zeolites therefrom. In one embodiment, zeolite LTA is formed from the pregnant leach solution. An additional source of aluminium is likely to be needed to be added to the pregnant leach solution in order to ensure that there is sufficient aluminium present in the solution to obtain the correct ratio of silicon to aluminium in the solution to obtain the desired zeolite. In one embodiment, step (e) comprises adding aluminate to the pregnant leach solution. Sodium aluminate they be used as the source of aluminate.

In step (e), the solution may be aged at a temperature of from about 60 to 95° C. with slow agitation for a period of from about 1 to about 4 hours.

In embodiments where aluminate is added to the solution, the aluminate may be added at room temperature and the solution may then be aged for about 15 to 30 minutes, followed by heating up to 80 to 95° C. with slow agitation for 1 to 4 hours. Zeolite LTA can be formed under these conditions. Other conditions may be used if other zeolites are designed to be formed. Seed particles may be added in step (e), if desired or required. The skilled person will readily understand how to generate zeolites, such as zeolite LTA, in step (e).

In other embodiments, step (e) may be conducted at a temperatures of from 60 to 95° C., or from 60 to 80° C., or from 60 to 70° C., with stirring that may be gentle agitation or vigorous agitation, for a period of from 30 minutes to 4 hours, or from 1 hour to 4 hours. Zeolite seed crystals may be added in step (e) to control the size of the zeolites being formed. The seed crystals may be added in an amount of from 10-20 g/L. The skilled person will understand that the addition of seed crystals may be varied in order to control formation of the zeolites. If required, a source of additional Al, such as an aluminate solution, may also be added to ensure the desired ratio of Al to Si is obtained in the precipitation step.

After zeolites have been formed in step (e), the solid zeolites may be separated from the solution. The solution will contain dissolved silicate/silicon and dissolved aluminium. This solution may be recycled to step (c) to minimise loss or wastage of the dissolved silicate/silicon and dissolved aluminium.

The process of the present invention uses a pre-wash or a pre-leach step to remove gypsum and/or sulphate from the leached spodumene residue. The solids from the pre-wash or pre-leach step have significantly reduced soluble gypsum/sulphate levels. For example, in some experimental work conducted by the present inventors, the pregnant leach solution formed in step (c) had a SO₄ concentration of less than 3 mM, or less than 2 mM, whereas a pregnant leach solution obtained by leaching leached spodumene residue without the prewash/pre-leach step of step (a) of the present invention had a SO₄ concentration of over 50 mM. Further, the present inventors found that without the pre-wash or pre-leach process of step (a) of the present invention, the pregnant leach solution had a sulphate content that resulted in the formation of low value sodalite, rather than the formation of high value zeolites such as zeolite LTA.

Preferred embodiments of the present invention utilise a combination of a pre-wash/pre-leach step to remove gypsum or sulphates from the leached spodumene residue, followed by a leaching step conducted under conditions that selectively dissolve aluminium and silicon/silicates into solution whilst leaving other components undissolved and part of the solid phase. This enables the formation of a pregnant leaching solution of adequate purity that can be subsequently used to prepare high value zeolites, such as zeolite LTA. The pre-wash/pre-leach step is conducted under relatively mild leaching conditions, suitably utilising a low caustic or alkali concentration, mild temperatures and relatively short leaching times. The leaching step is conducted at higher temperature and with a higher concentration caustic solution or alkali solution.

In some embodiments, the leached spodumene residue used as a feed has an approximate composition of from 10 to 25 wt % Al₂O₃, up to 25% CaO, 0.5-10% SO₃, 35-70% SiO₂, balance other components. It may have a loss on ignition from 10 to 20% by weight (unless otherwise noted, all percentages are in weight percent of the total feed material). The leached spodumene residue used as a feed material may comprise from 45 to 60% leached spodumene, 5 to 20% gypsum, 5 to 15% quartz and from 20 to 35% calcite.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a flowsheet of an embodiment of the present invention;

FIG. 2 is a graph of concentration of Al, S and Si in the solution formed in the pre-wash or pre-leaching step (step (a)) at various operating conditions;

FIG. 3 is a graph of Al concentration in the leach solution in step (b) vs time at 50 g/L NaOH concentration and at varying temperatures:

FIG. 4 is a graph of Al concentration in the leach solution in step (b) vs time at 70° C. for varying starting NaOH concentrations in the leach solution;

FIG. 5 is a graph of concentration of Al, S and Si in the pregnant leach solution at varying starting NaOH concentrations and temperatures,

FIG. 6 is a photomicrograph of zeolites formed in one of the examples;

FIG. 7 shows the particle size distribution for Feed B, as used as a feed material in Example 2;

FIG. 8 shows a graph of Al concentration in solution vs time for different leaching temperatures in Example 2:

FIG. 9 shows a graph of Al concentration in solution vs time for different solids loading in the leaching step in Example 2;

FIG. 10 shows a graph of Al concentration vs time for varying solids loadings in the leaching step of Example 3;

FIG. 11 shows a graph of Al concentration vs time for varying NaOH concentrations in the leaching step of Example 3;

FIG. 12 shows an analysis of the precipitated zeolites formed in Example 3, showing that pure zeolite LTA was formed;

FIG. 13 shows particle size distribution for Feeds C and D, expressed as volume % vs particle size (not cumulative);

FIG. 14 shows a graph of Al concentration in solution vs time for each leach solution tested in Example 4; and

FIG. 15 shows an analysis of the precipitated zeolites formed in Example 4, showing that pure zeolite LTA was formed.

### DESCRIPTION OF EMBODIMENTS

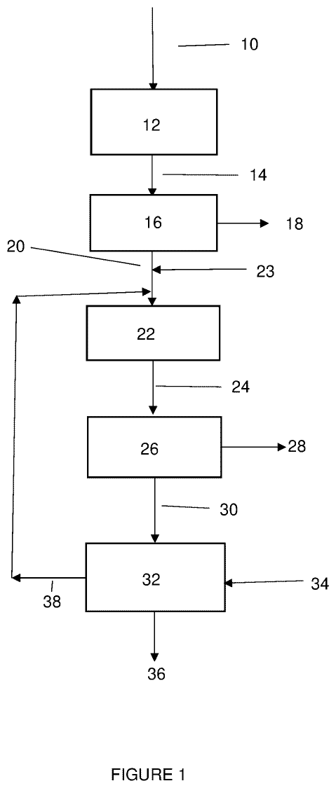

FIG. 1 shows a flowsheet of one embodiment of the present invention. In the process flowsheet shown in FIG. 1, leached spodumene residue 10 is fed to a pre-wash or pre-leaching vessel 12. In vessel 12, the leached spodumene residue 10 is contacted with a 0.5˜1M sodium hydroxide solution at a temperature of 25° C. (or ambient temperature). A residence time of from 30 minutes to 1 hour is used in the pre-wash or pre-leaching step 12 and a solids loading of 50 to 200 g/L is used. The mild conditions used in the prewash or pre-leaching step 12 result in the dissolution of gypsum that is present in the leached spodumene residue 10. Suitably, the temperature used in the prewash/pre-leaching stage will be less than 50° C. If a temperature above 50° C. is used, this is likely to cause dissolution of the leached spodumene residue, which results in the loss of both Al and Si.

The optimal pre-wash/pre-leach conditions are 0.5-2M NaOH solution, 0.5-2 hours washing time with solids loading of 50-200 g/L at temperature of 50° C. or less. After the pre-wash/pre-leaching step, the gypsum phase is virtually undetectable. Some of the dissolved gypsum re-precipitates as calcium hydrate, in accordance with the following reaction:

Ca(SO₄)₂*0.5(H₂O)+2NaOH→Ca(OH)₂↓+Na₂SO₄+0.5H₂O

Another option for the pre-wash is 0.5-2M Na₂CO3 solution, 0.5-2 hours washing time with solids loading of 50-200 g/L at temperature of 50° C. or less.

Ca(SO₄)₂*0.5(H₂O)+Na₂CO3→CaCO₃↓+Na₂SO₄+0.5H₂O

Some of the gypsum may be coated with calcium hydroxide, which acts to passivate that gypsum and effectively renders it inert to further leaching.

The pulp or mixture 14 is removed from pre-wash or pre-leaching vessel 12 and transferred to solid/liquid separation stage 16. In the flowsheet shown in FIG. 1, the solid/liquid separation step 16 is a filtration step. The liquid phase 18 is separated from the solid phase 20.

The solid phase 20 comprises leached spodumene residue having a lower gypsum/sulphate content, when compared to feed leached spodumene residue 10. In some embodiments, the solid phase 20 is subjected to a further pre-wash/pre-leach step before being sent to the leaching vessel 22. Although this option is not shown in FIG. 1, the skilled person will readily understand how this will operate.

The solid phase 20 is transferred to leaching vessel 22, where it is mixed with alkaline solution 23. The alkaline solution 23 may comprise a molarity of about 4M. The leaching step conduct in vessel 22 occurs at a temperature of from 60 to 80° C., with 70° C. being preferred, with a residence time of from 0.5 to about 6 hours, with 2 to 4 hours being preferred. The solids loading in leaching step 22 is from 40 to 75 g/L.

Leaching step 22 selectively leaches aluminium and silicon/silicate into solution. Other components, such as quartz, calcite and calcium hydroxide and calcium hydrate, are not leached to any appreciable extent and remain with the solids phase.

The slurry mixture or pulp 24 is removed from leaching vessel 22 and supplied to solid/liquid separation stage 26. Filtration may be used in this solid/liquid separation step. The solids 28 are separated from the liquid phase 30. Liquid phase 30 comprises a pregnant leach solution containing dissolved aluminium and dissolved silicon/silicate. The pregnant leach solution 30 is fed to crystallisation stage 32. An additional source of aluminium 34, which may comprise sodium aluminate, may be supplied to crystallisation stage 32 to ensure that the correct ratio of aluminium to silicon is obtained to produce the desired zeolite, such as zeolite LTA. In crystallisation stage 32, the pregnant leach solution with added aluminate is heated up to 70 to 95° C. with agitation for 1-4 hours to cause zeolite, such as zeolite LTA, to precipitate. Seed crystals may also be added. The precipitated zeolites are removed at 36. The remaining solution following crystallisation is separated and sent via line 38 to be recycled back to the leaching stage 22. Although FIG. 1 shows all of the remaining solution being recycled back to leaching stage 22, it will be appreciated that only part of that solution may be recycled.

The zeolites 36 may then be dried and recovered for use.

### EXAMPLES

The test work was conducted using the following general procedure:

### Pre-Wash Stage:

1. The received leached spodumene (LS) residue was added to the caustic solution and stirred without heating.
2. Once the pre-wash reaction was completed in setting time, solids and liquids were separated through filtration. Depending on the total content sulfate in the residue, the pre-wash may require two stages.
   The pre-washed residue was washed and used for selective leaching stage.

### Leaching Stage:

1. The synthetic caustic liquor with caustic concentration was stirred.
2. The solution was heated by a hotplate with a temperature feedback controller.
3. When the set-point temperature was reached, pre-washed samples were added to the heated solution.
4. Once the leaching reaction was completed in setting time, solids and liquids were separated through vacuum filtration.
   The leached solution is then used for the precipitation of final zeolite products.

### Crystallization Stage:

1. The obtained solution from leaching stage is transferred into precipitation flask and precipitated at specified temperature and time with agitation. The agitation speed need to be specified (high agitation speed prefer) to control kinetics and product particle size.
2. To synthesis different types of zeolites, the extra silica or aluminium source may be needed to balance molar ratio of SiO₂/Al₂O₃.
3. The solid product was separated from the solution by filtration, washed, dried in oven.

The test work was conducted on 4 different leached spodumene residues, designated as Feed A, Feed B, Feed C and Feed D. The feed samples had the following compositions:

| Sample | | | | | | | | |
|---|---|---|---|---|---|---|---|---|
| (%) | Al₂O₃ | SiO₂ | TiO₂ | Fe₂O₃ | CaO | Na₂O | K₂O | SO₃ |
| Feed A | 14.85 | 42.3 | 0.04 | 0.63 | 18.55 | 0.23 | 0.38 | 5.4 |
| Feed B | 23.56 | 68.2 | 0.08 | 0.83 | 0.36 | 0.18 | 0.6 | 0.73 |
| Feed C | 19.0 | 53.6 | 0.04 | 1.44 | 7.85 | 0.54 | 0.68 | 8.37 |
| Feed D | 19.12 | 55.20 | 0.06 | 0.77 | 9.32 | 0.28 | 0.47 | 7.24 |

### Example 1

Laboratory scale experimental work was conducted to investigate embodiments of the process in accordance with the present invention. The leached spodumene residue (Feed A), had the following approximate composition:

TABLE 1

| Mineral phase based on XRF and XRD | Concentration (%) |
|---|---|
| Leached Spodumene, ½(H₂O*Al₂O₃*4SiO₂) | ~52.7 |
| Gypsum, syn (Ca(SO₄)(H₂O)₂) | ~11.6 |
| Quartz, syn (SiO₂) | ~7.4 |
| Calcite, syn (Ca(CO₃)) | ~28.3 |

The following general synthesis procedure was used:

### Pre-Wash Stage:

1. The received leached spodumene (LS) residue was added to the caustic solution and stirred without heating.
2. Once the pre-wash reaction was completed for the desired time, solids and liquids were separated through vacuum filtration.
3. The pre-washed residue was washed and dried and then used for selective leaching stage.

### Leaching Stage:

1. A synthetic caustic liquor with caustic concentration was stirred.
2. The solution was heated by a hotplate with a temperature feedback controller.
3. When the set-point temperature was reached, samples of the solids from the pre-wash stage were added to the heated solution.
4. Once the leaching reaction was completed for the desired time, solids and liquids were separated through vacuum filtration.
5. The leached solution is then used for the precipitation/crystallisation of final zeolite products.

### Crystallization Stage:

1. The obtained solution from leaching stage is transferred into a precipitation flask and precipitated at specified temperature and time with agitation.
2. To synthesise different types of zeolites, extra silicate or aluminium source may be needed to balance molar ratio of SiO₂/Al₂O₃.
3. The solid product was separated from the solution by filtration, washed, dried in oven.

### Results:

### Pre-Wash/Pre-Leach

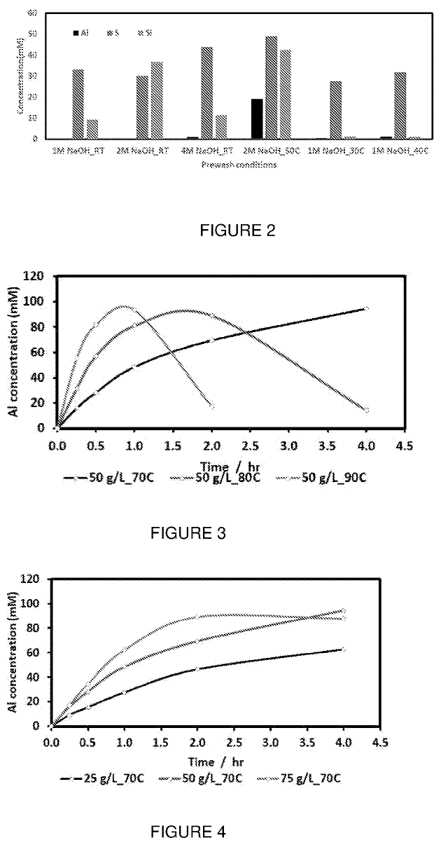

A number of different leaching conditions were used in the pre-wash stage to try to determine the most appropriate leaching conditions. The leach solutions arising from these tests were analysed for aluminium content, sulphur content (which equates to sulphate dissolution or gypsum dissolution) and silicon content. In this step, it is desired that the leach solution has low levels of dissolved aluminium and silicon and high levels of dissolved sulphur/sulphate, which will indicate selective dissolution of the gypsum. FIG. 2 shows the results obtained from analysing the resulting leach solutions. In FIG. 2, the left-hand bar of each set corresponds to Al, the middle bar corresponds to S and the right-hand bar corresponds to Si in solution. As can be seen from FIG. 2 significant dissolution of silica occurred when the sodium hydroxide concentration was 2M or greater. Significant Al and Si dissolution occurred when the prewash step used a sodium hydroxide concentrations of 2M or greater at 50° C. Acceptable levels of Al and Si dissolution occurred at 1M sodium hydroxide concentration and temperatures of 40° C. or lower. It is noted that a test conducted at 1M NaOH and 50° C. was not conducted.

In order to investigate the effect of varying residence time in the prewash stage, a series of tests at 50 g/L solid loading, 2 hours residence time and 1M sodium hydroxide solution at room temperature with agitation were conducted. The following solution analyses were obtained:

TABLE 2

| Elemental | | | |
|---|---|---|---|
| concentration (mM) | Al | SO₄ | Si |
| 0.25 h | 2.11 | 31.34 | 7.81 |
| 0.5 h | 1.28 | 29.8 | 7.93 |
| 1 h | 0.90 | 31.34 | 8.33 |
| 2 h | 0.63 | 31.71 | 8.71 |

These tests showed that a leaching time of from 0.25 hours to 2 hours produce acceptable results. The dissolved aluminium content likely decreases with time due to precipitation of aluminosilicates.

### Leaching Stage

The solid residue obtained from the prewash stage was subsequently treated under varying leaching conditions and the dissolved Al concentration in the pregnant leach solution is shown in FIGS. 3 and 4. It can be seen from FIG. 3 that a combination of 70° C. and a leaching time of 2 to 4 hours provide a good results. Higher temperatures of 80° C. and 90° C. can use shorter leaching times. However, dissolved Al concentration decreased at 80° C. and 90° C. if the leaching time was too long, probably due to precipitation of aluminosilicates.

FIG. 4 shows the effect of varying the solid loading in the leaching step. As can be seen from FIG. 4, acceptable results are obtained using a solid loading from 25 g/L to 75 g/L, with 50 g/L and a leaching time of 4 hours showing best results.

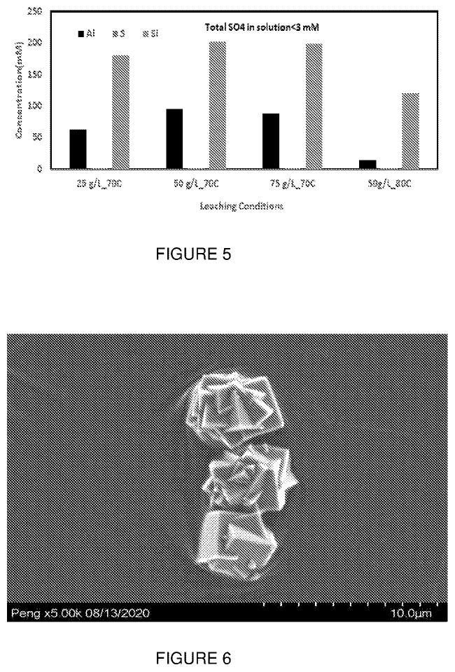

FIG. 5 shows the concentration of Al, S and Si in the pregnant leaching solution under different leaching conditions of solid loading and temperature. In all cases, the total SO₄ in solution was less than 3 mM.

Under conditions of solid loading of 50 g/L, varying leaching time and 4M sodium hydroxide solution, 70° C. with agitation, the following elemental concentrations were achieved in the pregnant leach solution at various leaching times:

TABLE 3

| Elemental | | | |
|---|---|---|---|
| concentration (mM) | Al | SO₄ | Si |
| 0.5 h | 28.24 | 0.52 | 44.14 |
| 1 h | 48.45 | 0.70 | 86.88 |
| 2 h | 69.39 | 0.74 | 134.54 |
| 4 h | 94.43 | 1.45 | 202.02 |

Again, these results show that a leaching time of up to 4 hours gave good results, with low concentrations of sulphate are maintained in the pregnant leach solution.

### Crystallisation Stage

In the crystallisation stage, zeolite LTA was crystallised/precipitated. For leached spodumene (H₂O*Al₂O₃*4SiO₂), its molar ratio of SiO₂ to Al₂O₃ is 4 while the molar ratio is 2 for the zeolite LTA (Na₂O*Al₂O₃*2SiO₂*4.5H₂O). Consequently, extra aluminate needs to be added during the crystallization stage to achieve the stoichiometric ratio required for zeolite LTA. With this in mind, sodium aluminate was added to the pregnant leach solution.

The crystallisation stage was conducted in the laboratory trials by adding sodium aluminate to the pregnant leach solution at room temperature and then ageing the mixture for 15 to 30 minutes, followed by heating up to 80 to 95° C. with slow agitation for 1 to 4 hours. Zeolite LTA crystallised and was separated from the solution by filtration, washed and dried in an oven.

The solution using the crystallisation stage was analysed for its various components and the results are shown below:

TABLE 4

| Elemental | | | |
|---|---|---|---|
| concentration (mM) | Al | SO₄ | Si |
| Before adding | 82.76 | 3.07 | 172.7 |
| sodium aluminate | | | |
| After adding sodium | 126.5 | 2.64 | 127.8 |
| aluminate-1 hr | | | |
| After adding sodium | 76.10 | 2.82 | 72.16 |
| aluminate-2 hr | | | |
| After adding sodium | 60.97 | 2.13 | 58.38 |
| aluminate-4 hr | | | |

A photomicrograph of the zeolite LTA produced in this example is shown in FIG. 6.

### Example 2

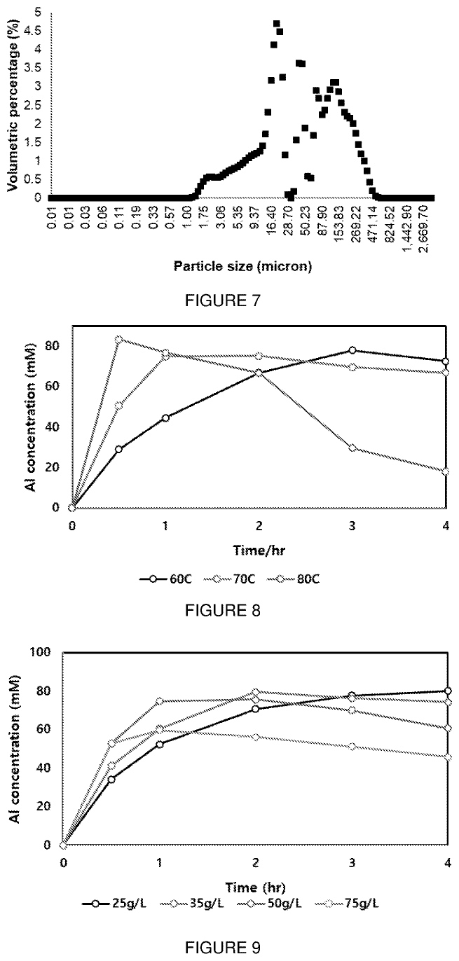

The particle size distribution for Feed B is shown in FIG. 7.

Feed B was subjected to a pre-wash step under conditions of 0.5˜1M NaOH, 0.5˜1 h washing time with solid loading 100˜200 g/L at room temperature. Solution samples were taken at various times during the pre-wash step and analysed for Al, SO₄ and Si content in the solution. The following results were obtained:

TABLE 5

| | Al | SO₄ | Si |
|---|---|---|---|
| Elemental Con.(mM)_0.5M | | | |
| NaOH, 100 g/L solid loading | | | |
| 0.25 h | 4.82 | 7.36 | 3.22 |
| 0.5 h | 5.56 | 6.72 | 4.91 |
| 1 h | 8.12 | 6.67 | 9.58 |
| Elemental Con.(mM)_0.5M | | | |
| NaOH 200 g/L solid loading | | | |
| 0.25 h | 8.04 | 13.52 | 3.68 |
| 0.5 h | 7.78 | 13.47 | 4.81 |
| 1 h | 7.77 | 13.61 | 7.51 |

The solids from the pre-wash step were then leached at 50-75 g/L solid loading, 4M NaOH at 70° C. for 2 hours. Samples of the leach solution were taken at various times during the leaching step and analysed for Al and Si concentration. The following solution analysis results were obtained:

TABLE 6

| Elemental | | |
|---|---|---|
| Concentration (mM) | Al | Si |
| 0.5 h | 50.60 | 141.52 |
| 1 h | 74.87 | 203.44 |
| 2 h | 75.21 | 224.82 |
| 3 h | 69.56 | 230.10 |
| 4 h | 66.90 | 241.82 |

FIGS. 8 and 9 show graphs of Al concentration in solution vs time for different leaching temperatures and Al concentration in solution vs time for different solids loading. These figures show that a leaching time of 2 hours is suitable at a solids loading of from 50 to 75 g/L.

The pregnant leach solution then underwent a precipitation process under conditions of 70° C. with 10 g/L of seeding. As the initial pregnant leach solution has higher Si concentration than Al as shown in Table 6, we added extra Al source (aluminate solution) to make up the pregnant solution with Al and Si ratio around 1. Samples of the solution in the precipitation step were withdrawn at various times and analysed for Al, SO₄ and Si content. The following results were obtained:

TABLE 7

| 70° C., | Al | SO₄ | Si |
|---|---|---|---|
| 10 g/L seeding (hrs) | (mM) | (mM) | (mM) |
| 0 | 138.82 | 3.17 | 128.22 |
| 0.5 | 126.26 | 3.12 | 115.92 |
| 1 | 117.32 | 3.06 | 105.32 |
| 1.5 | 77.82 | 2.90 | 64.43 |
| 2 | 69.74 | 2.75 | 56.24 |
| 2.5 | 68.92 | 3.10 | 55.53 |
| 3 | 66.47 | 3.34 | 53.23 |

It can be seen that the SO₄ content in solution remained at a very steady level, indicating that SO₄ was not being precipitated with the zeolites. Analysis of the zeolites indicated that essentially pure zeolite LTA was obtained. In contrast, precipitation at 80° C. and otherwise identical conditions resulted in the formation of a mixture of zeolite LTA and sodalite.

### Example 3

Due to the high sulphate content, Feed C was subjected to a 2 stage pre-wash step under the following conditions:
Step 1) 1M NaOH, 200 g/L solid loading, room temperature
Step 2) 1M NaOH, 200 g/L solid loading, room temperature.

Samples of the pre-wash solution were taken at various times and analysed for Al, SO₄ and Si content. The following results were obtained:

TABLE 8

| | Al | SO₄ | Si |
|---|---|---|---|
| | (mM) | (mM) | (mM) |
| 1M NaOH, 200 g/L solid | | | |
| loading, Stage 1 | | | |
| 0.25 h | 0.02 | 168.44 | 0.38 |
| 0.5 h | 0.05 | 158.27 | 0.4 |
| 1 h | 0.03 | 151.76 | 0.45 |
| 1M NaOH, 200 g/L solid | | | |
| loading, Stage 2 | | | |
| 0.25 h | 0.13 | 7.95 | 0.93 |
| 0.5 h | 0.21 | 8.83 | 1.14 |
| 1 h | 0.18 | 9.88 | 1.19 |

The optimal pre-wash condition for feed C was found to be 0.5˜1 M NaOH, 0.5˜1 h for two stages due to high sulfate content with solid loading 100˜200 g/L at room temperature.

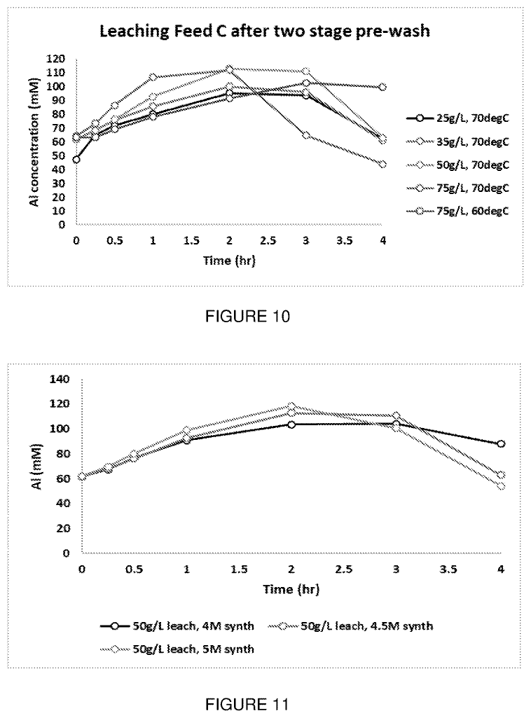

The solids from the second pre-wash step was then leached at various temperatures and solids loadings. FIG. 10 shows a graph of Al concentration vs time for varying solids loadings and FIG. 11 shows a graph of Al concentration vs time for varying NaOH concentrations. From these results, it was determined that optimal selective leaching occurs at 50˜75 g/L of solid loading, 4.5M NaOH at 70° C. for 2 hours.

The pregnant leach solution then underwent a precipitation process under conditions of 70° C. with 10 g/L of seeding. Samples of the solution in the precipitation step were withdrawn at various times and analysed for Al, SO₄ and Si content. The following results were obtained:

TABLE 9

| 70 degree C., | Al | SO4 | Si |
|---|---|---|---|
| 10 g/L seeding (hrs) | (mM) | (mM) | (mM) |
| 0 | 178.35 | 4.96 | 178.55 |
| 0.5 | 156.39 | 4.94 | 155.90 |
| 1 | 146.61 | 4.65 | 147.06 |
| 2 | 146.21 | 5.05 | 146.45 |
| 3 | 90.84 | 4.89 | 91.68 |

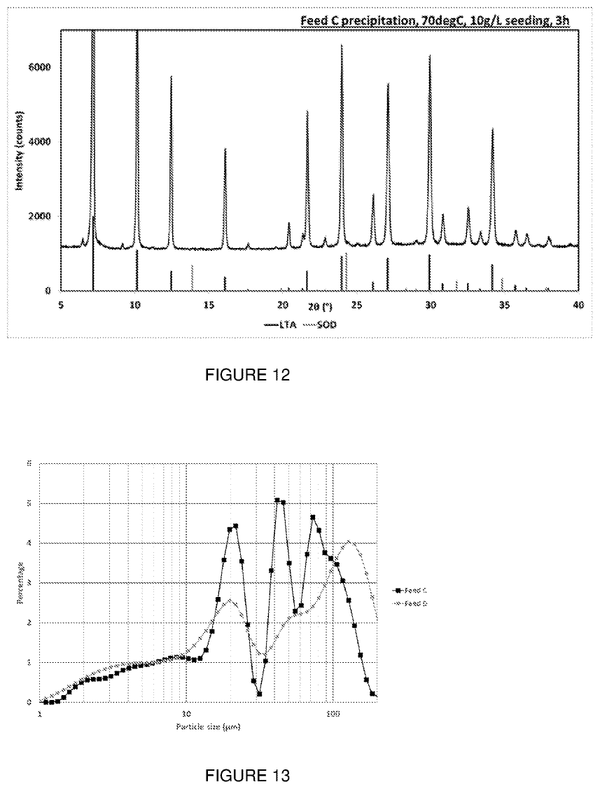

The precipitated zeolites were analysed and found to be pure zeolite LTA, as shown in FIG. 12.

### Example 4

Example 4 details preliminary experimental work on Feed D. FIG. 13 shows the particle size distribution for Feeds C and D.

Although Feed D also has a high sulphate content, it is not as high as Feed C, and a single stage pre-wash was found to be suitable. The optimal pre-wash condition was found to be 0.5˜1 M NaOH, 0.5˜1 h with solid loading of 50˜100 g/L at room temperature.

Solution samples were taken at various times during the pre-wash step and analysed for Al, SO₄ and Si content in the solution. The following results were obtained:

TABLE 10

| | Al | SO4 | Si |
|---|---|---|---|
| | (mM) | (mM) | (mM) |
| 1M NaOH, 100 g/L | | | |
| solid loading | | | |
| 0.25 h | 1.42 | 75.48 | 1.62 |
| 0.5 h | 1.11 | 76.35 | 1.79 |
| 1 h | 1.18 | 77.94 | 2.40 |
| 1M NaOH, 50 g/L | | | |
| solid loading | | | |
| 0.25 h | 0.82 | 41.34 | 2.86 |
| 0.5 h | 1.39 | 41.30 | 3.29 |
| 1 h | 1.87 | 41.89 | 3.64 |

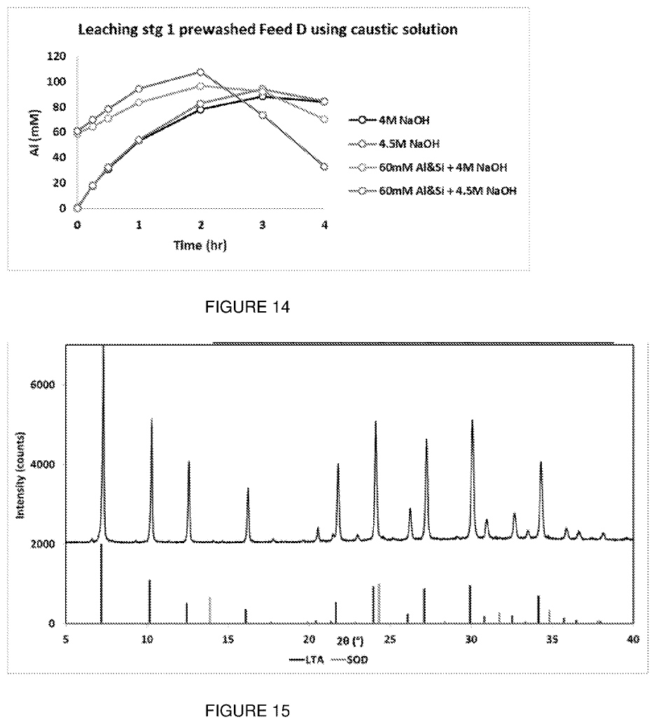

The solids from the pre-wash step were then subjected to leaching at conditions ranging from 50-75 g/L solids loading, 4M NaOH solution, 4.5M NaOH solution, a synthetic solution containing 4M NaOH and 60 mM AL and Si, and a synthetic solution containing 4.5M NaOH and 60 mM Al and Si. Solution analyses were conducted to determine Al concentration in solution vs time for each solution used and the results are shown in FIG. 14.

From FIG. 14, the best results were obtained using a synthetic leach solution containing 4.5M NaOH and 60 mM Al and Si using a solids loading of 50-75 g/L at 70° C. for 2 hours. In this example, the initial leaching solution was started with an extra 60 mM Al and Si to simulate the recycled spent liquor after precipitation. The solution analysis vs time for this leaching step is shown in Table 11.

TABLE 11

| 70 degree C., | Al | SO4 | Si |
|---|---|---|---|
| 4.5M NaOH(hrs) | (mM) | (mM) | (mM) |
| 0 | 60.89 | 0 | 64.05 |
| 0.5 | 78.42 | 4.63 | 94.41 |
| 1 | 94.29 | 4.67 | 127.49 |
| 2 | 107.50 | 4.61 | 165.51 |
| 3 | 73.82 | 4.23 | 152.06 |
| 4 | 33.18 | 2.88 | 137.70 |

The leaching solution was then subject to precipitation to form zeolites, using conditions of 70° C. for 4 hours, with a solution analysis vs time being shown in Table 12. As the initial pregnant leach solution has higher Si concentration than Al, we added extra Al source to make up the pregnant precipitation solution with Al and Si ratio around 1.

TABLE 12

| 70 degree C., | Al | SO4 | Si |
|---|---|---|---|
| 20 g/L seeding (hrs) | (mM) | (mM) | (mM) |
| 0 | 168.39 | 1.62 | 167.39 |
| 0.5 | 161.79 | 1.53 | 152.26 |
| 1 | 139.79 | 1.44 | 131.89 |
| 2 | 153.5 | 1.57 | 140.71 |
| 3 | 78.95 | 1.75 | 142.68 |

An analysis of the zeolites obtained showed that pure zeolite LTA was obtained, as shown in FIG. 15.

Although the experimental work conducted above all related to a process for treating leached spodumene residue, the present inventors believe that the pre-wash step (which is step (a) of the present invention) will also be effective to selectively remove sulphates and other impurities, such as arsenic, boron and vanadium, from a feed material without dissolving significant amounts of other potentially valuable materials, such as Si or Al, in the feed material, thereby allowing for later treatment of the solid material from the pre-wash step to recover or utilise those other valuable materials, for example, to form zeolites. Therefore, the present invention should not be considered to be limited to treatment of leached spodumene residue. Rather, the present invention, in general terms, is directed towards impurity management in a feed material so that the impurities are removed from the solids, thereby facilitating downstream treatment of the solids. In some embodiments, the downstream processing of the solids involves leaching the solids to dissolve Si and/or Al, and subsequently forming zeolites from the leach solution. However, other downstream processing steps may also be used to recover or form valuable materials from the pre-washed solids.

Throughout this specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A process for treating a material to remove sulphates or other impurities therefrom, the process comprising:
a) subjecting the material to a leaching step to selectively dissolve sulphate-containing material or dissolve other impurities from the material and/or to passivate gypsum,
b) separating a leach solution generated in step (a) from solids, and
c) treating the solids from step (b).

2. A method as claimed in claim 1 wherein the other impurities may comprise one or more of arsenic, boron, tungsten, phosphorus and vanadium.

3. A method as claimed in claim 1 or claim 2 wherein step (a) comprises a neutral leach or a water wash at neutral pH, or an alkaline leach.

4. A method as claimed in any one of claims 1 to 3 wherein step (a) is conducted to minimise or avoid dissolution of silicate/silicon components and aluminium components from the material.

5. A method as claimed in any one of the preceding claims wherein step (a) is conducted at a temperature of less than 50° C., or less than 40° C., or at ambient temperature, or without any additional heating, and an alkaline solution corresponding to 0.5 to 2M NaOH, or 0.5 to 1.5M NaOH, or 0.5 to 1.25M NaOH, or 0.5 to 1M NaOH is used, and the alkaline solution comprises a hydroxide solution or a carbonate solution or mixtures thereof.

6. A method as claimed in any one of the preceding claims wherein step (a) is conducted with a solids loading of approximately 50 to 250 g, or from 50 to 200 g, or from 100 to 200 g of leached spodumene residue per litre of leachant solution and a residence time of from about 0.25 to about 4 hours, or from about 0.5 to about 2 hours, or from about 0.5 to about 1 hour.

7. A method as claimed in any one of the preceding claims wherein step (a) reduces the amount of soluble gypsum or soluble sulphate or other impurities in the material by at least 50%, or by at least 60%, or by at least 70%, or by at least 80%, or by at least 90%, or around 90 The solids from step (a) have reduced levels of gypsum or sulphate and preferably have low levels of gypsum or sulphate, when compared to the starting material.

8. A method as claimed in any one of the preceding claims wherein less than 20% of the silicate/silicon components and/or aluminium components, or less than 10% of the silicate/silicon components and/or aluminium components, in the feed material are dissolved in step (a).

9. A method as claimed in any one of the preceding claims wherein the process comprises repeating steps (a) and (b) one or more times.

10. A method as claimed in any one of the preceding claims wherein step (c) comprises a leaching step to leach Si and/or Al into solution.

11. A method as claimed in claim 10 wherein the process comprises:
c) leaching the solids from step (b) to dissolve aluminium and silicate into solution and form a pregnant leach solution containing dissolved aluminium and silicon/silicate,
d) separating the pregnant leach solution from solids, and
e) treating the pregnant leach solution to form zeolites.

12. A method as claimed in claim 11 wherein the pregnant leach solution containing dissolved aluminium and dissolved silicate that is generated in step (c) is separated from the solids and separated solids residue, which contains quartz, calcite and calcium hydroxide, is disposed of or sent for any other use.

13. A method as claimed in claim 11 or claim 12 wherein step (c) comprises leaching the solids with an alkaline leach solution corresponding to a 2M to 6M NaOH solution, or a leach solution corresponding to a 3M to 5M NaOH solution, or a leach solution corresponding to a 4M to 4.5M NaOH solution, or a leach solution corresponding to about 4M NaOH. T

14. A method as claimed in any one of claims 11 to 13 wherein a temperature in step (c) ranges from 50° C. up to the boiling point of the mixture at atmospheric pressure, or from 60° C. to 90° C., or from 60° C. to 80° C., or from 70° C. to 80° C., or about 70° C.

15. A method as claimed in any one of claims 11 to 14 wherein a leaching time of up to 6 hours, or from about 0.5 to about 6 hours, or from about 2 to about 4 hours, is used in step (c).

16. A method as claimed in any one of claims 11 to 15 wherein step (e) comprises adding an additional source of aluminium to the pregnant leach solution in order to ensure that there is sufficient aluminium present in the solution to obtain the correct ratio of silicon to aluminium in the solution to obtain the zeolite.

17. A method as claimed in any one of claims 11 to 16 wherein in step (e), the solution is aged at a temperature of from about 60 to 95° C. with agitation for a period of from about 1 to about 4 hours and optionally with addition of seed crystals.

18. A method as claimed in any one of claims 11 to 17 wherein the zeolites are separated from the solution and the solution is recycled to step (c).

19. A process as claimed in any one of the preceding claims wherein the material is one or more of leached spodumene residue, or leached jadarite residue, or a mining tailings containing silicate/silicon components and/or aluminium components, or a kaolin-containing material or a kaolinite-containing material, or a clay-containing material, or aluminium hydroxy-sulfates, fly ash, or colloidal silica.

20. A process for producing zeolites from leached spodumene residue, the leached spodumene residue including gypsum, the process comprising
a) subjecting the leached spodumene residue to a leaching step to selectively dissolve gypsum from the leached spodumene residue and/or to passivate gypsum,
b) separating a leach solution generated in step (a) from solids,
c) leaching the solids from step (b) to dissolve aluminium and silicate into solution and form a pregnant leach solution containing dissolved aluminium and silicon/silicate,
d) separating the pregnant leach solution from solids, and
e) treating the pregnant leach solution to form zeolites.

21. A process as claimed in claim 20 wherein a solution recovered from step (e) is at least partly recycled to step (c).
